(19) United States
(12) Patent Application Publication
(10) Pub. No.: US 2016/0232316 A1
(43) Pub. Date: Aug. 11, 2016

(54) Method And System For Massage Therapy App

(71) Applicant: Alexander Vanifatev, DES PLAINES, IL (US)

(72) Inventor: Alexander Vanifatev, DES PLAINES, IL (US)

(21) Appl. No.: 14/618,886

(22) Filed: Feb. 10, 2015

(51) Int. Cl. G06F 19/00; G06F 17/30; G06Q 30/02; G06Q 10/10

(52) U.S. Cl. CPC G06F 19/3418; G06Q 10/1095; G06F 17/30241; G06F 17/30867; G06F 17/30528; G06Q 30/0256

(57) ABSTRACT

Disclosed are a method and system for bridging the gap between professionals and customers over a communication network on mobile devices. The system and method comprises an interface for professionals that allows the professionals to manage profiles, upload products and services offered to customers, manage appointment, and interact with customers; and an interface for customers that allows the customers to locate professionals per their need, view the profiles of the matched professionals and their products and services, make appointment, interact with the professionals, and rate the professionals. The professionals include but are not limited to physical therapists, massage therapists, etc.

### BACKGROUND OF THE INVENTION

1. Field of the Invention

The present invention relates to a system and method for mobile device applications, and more particularly to a system and method for bridging therapists and customers via communication networks on mobile devices.

2. Description of Related Art

For small business professionals to set up and maintain a website to introduce their business may not be economically efficient. This is especially true for physical therapists and massage therapists who exist but may not be known by even local people who need services. Thus, there is a need for an easy to use platform that allows for these therapists to easily expose themselves and their skills in a public arena. Also, there is a need to have a platform that allows people who need services to conveniently locate the therapists who offer services that best suit them. People who got massages can review the services they received so other users can be better informed.

It is necessary to have a platform that allows both the massage therapists and people seeking a massage to easily manage their massage sessions and to easily communicate with one another to arrive on the best massage experience.

The adoption and usage of applications (apps) on mobile devices continue to increase at a rapid rate due to their convenience & benefits. Therefore, it is desirable to have an app that can be used as the aforementioned platform to bridge the gap between therapists and their customers.

### SUMMARY OF THE INVENTION

One primary object of the present invention is to bridge the gap between therapists and clients.

A further object of the present invention is to provide customers the convenience of locating massage therapists, viewing their profiles, ratings and all other details along with setting appointments, getting to know all the massage therapy options, checking out their products on sale, gallery, and chatting with them instantly.

Yet another further object of the present invention is to provide an app on mobile devices which will allow for the massage therapists to expose themselves and their skills, build on a strong profile supported with their work gallery and the services they offer.

Still another object of the present invention is to allow the massage therapists to build on their clientele and work on their weak areas based on the ratings they receive.

The mobile devices described herein include but are not limited to smart phones, tablets, laptops, etc.

In an exemplary embodiment of the present invention, there is disclosed a system and method that bridge the gap between therapists and customers.

The system and method for bridging the gap between professionals and customers comprises:

an interface for professionals in an application that runs on a mobile device over a communication network to login using the professional's identification and associated information;

an interface for customers in the application that runs on the mobile device over the communication network to login using customer's identification and associated information, and to place search request for professionals per need,

a server system that receives the professional's identification and associated information or the customer's identification and associated information, and verifies that the professional is registered with the application; and

a database storing the professional's identification and associated information as well as the customer's identification and associated information;

wherein the server system accesses the database to retrieve the matched professional's associated information upon the search request placed by the customer and transmits the associated information over the communication network to display via the interface for customers on the mobile device.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a chart showing the control flow for the therapist.

FIG. 2 is a chart showing the control flow for the customer.

FIG. 3 shows a Splash screen of an application on the mobile device.

FIG. 4 is a snapshot of the therapist Login module.

FIG. 5 is a registration screen (left) and an in-app purchase module for the therapist to pay (right).

FIG. 6 is a dashboard/main screen where multiple sections are available for the therapist to interface with the system.

FIG. 7 is a screenshot of the section of Manage Account/My Profiles.

FIG. 8 is a screenshot of the section of Store.

FIG. 9 is a screenshot of the section of Services.

FIG. 10 is a screenshot of the section of My Appointment.

FIG. 11 is a screenshot of the section of My Appointment (continued).

FIG. 12 is a screenshot of the section of Messages.

FIG. 13 is a screenshot of the section of Promotions.

FIG. 14 is a screenshot of the section of Gallery.

FIG. 15 is a screenshot of the section of Clientele.

FIG. 16 is a screenshot of the Customers Login.

FIG. 17 is a screenshot of the Customer Dashboard.

FIG. 18 is a screenshot of the section of Locate Massage Therapist.

FIG. 19 is a screenshot of the section of Store

FIG. 20 is a screenshot of the section of My Favorite.

FIG. 21 is a screenshot of the section of My Appointment.

FIG. 22 is a screenshot of the section of Messages.

FIG. 23 is a screenshot of the section of Settings.

FIG. 24 is a screenshot of the section of About Us.

FIG. 25 is a screenshot of the section of Notification.

### DESCRIPTION OF THE PREFERRED EMBODIMENT

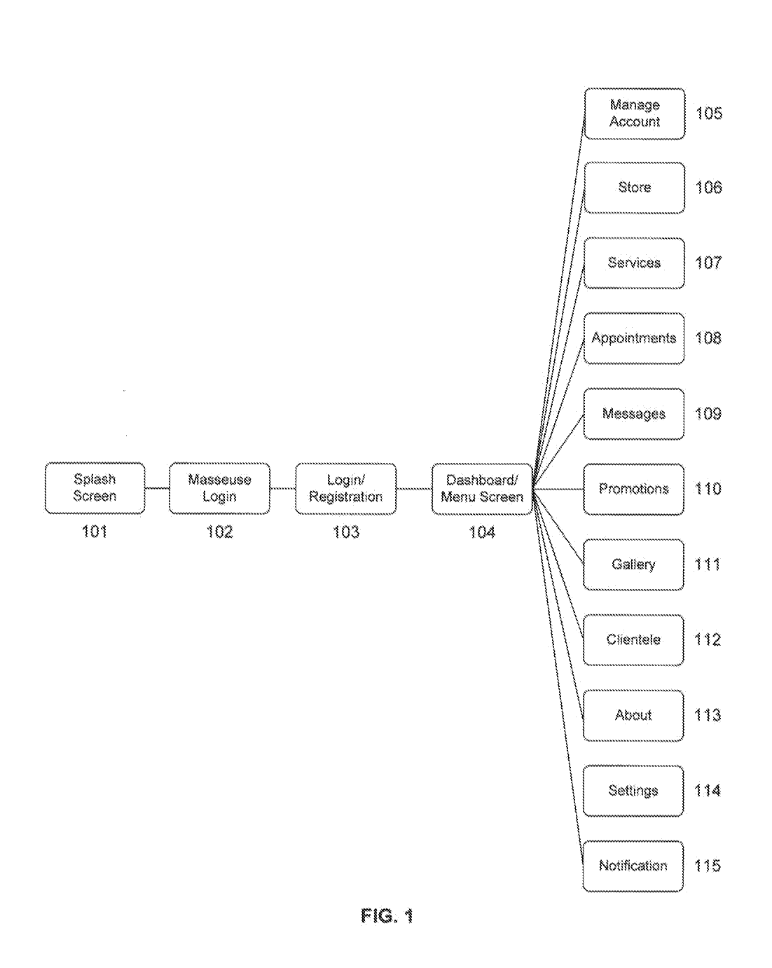

Referring to FIG. 1, there is disclosed a chart showing the control flow for the therapist. The control flow starts with the splash screen 101 followed by the masseuse login 102, login/registration 103, and dashboard/menu 104. The dashboard/menu 104 comprises: Manage Account 105, Store 106, Services 107, Appointments 108, Messages 109, Promotions 110, Gallery 111, Clientele 112, About 113, Settings 114, and Notification 115.

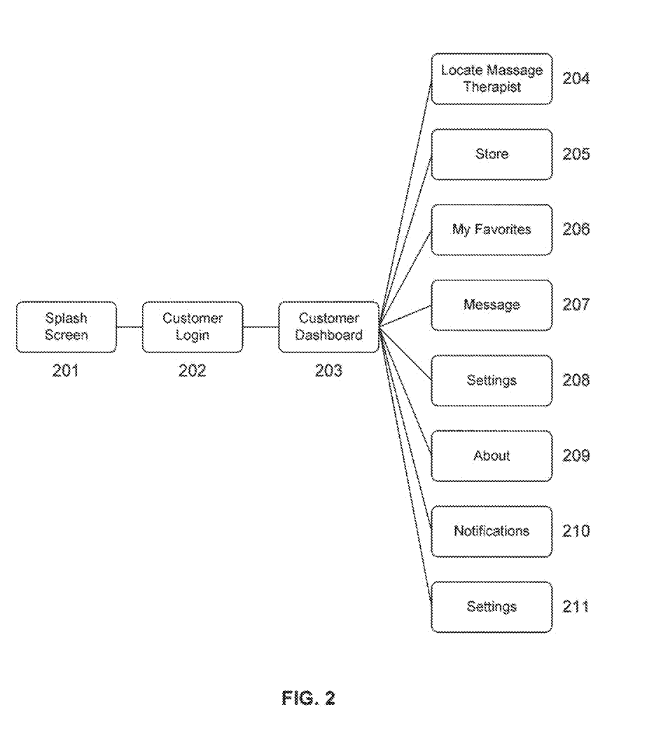

Referring to FIG. 2, there is disclosed a chart showing the control flow for the customers. The control flow starts with the splash screen 201 followed by the customer login 202, customer dashboard 203 which comprises: locate massage therapist 204, store 205, my favorites 206, my appointment 207, message 208, settings 209, about 210, and notifications 211.

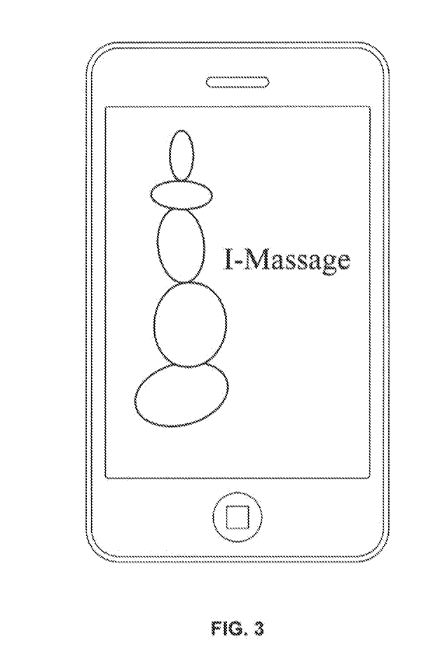

FIG. 3 shows that upon clicking the application icon on the phone, the user will be presented with Splash screen 101 that will have an eye catching interface along with application name and logo. Splash screen 101 will serve as a loading screen for the application.

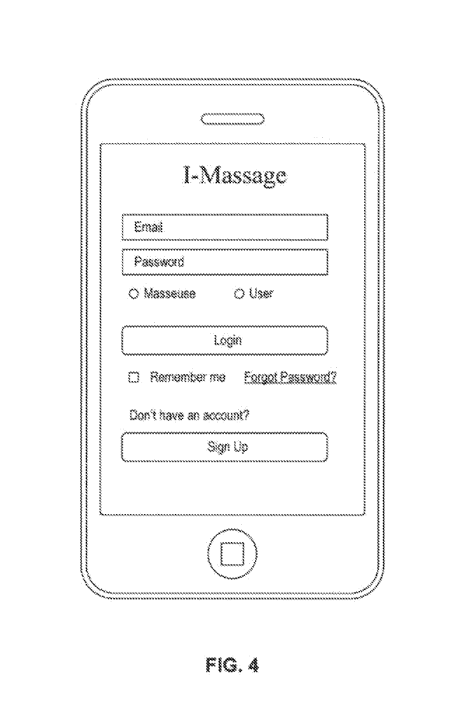

FIG. 4 shows that followed by Splash screen 101 user will be presented with the Login module where user would be able to enter his/her credentials in order to access the content. To login, they will essentially have to use their login credentials, their email ID, and password. User can also check remember me checkbox for the application to remember the user's credentials so they won't be prompted next time. User can also recover their password through forgot password option. Tapping on forgot password option will send user's password to the email the user provided. New user can create their account by tapping on Sign Up.

In the Login module the user can choose to login as a masseuse or a customer (user) by checking the masseuse or the user box. As a masseuse the user should check masseuse box to register as a massage therapist. As a customer the user should check the customer (user) box to register as a customer.

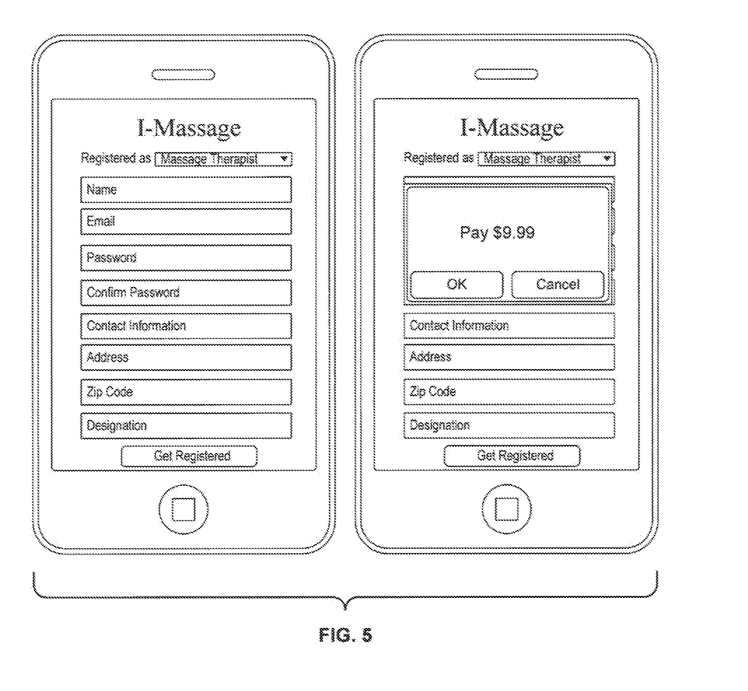

FIG. 5 shows the registration screen which will have a drop down to choose between Massage Therapist and user. If user chooses Massage Therapist from the drop down, there will be an in-app purchase module so therapist can pay and get himself registered for the application. Registration will be subjected to approval by the administrator. Registration will be free for normal users or customers. In Registration screen Therapists will be required to enter their following information:
Full Name
Email address
Password
Contact Information
Address
Zip code
Designation/Title

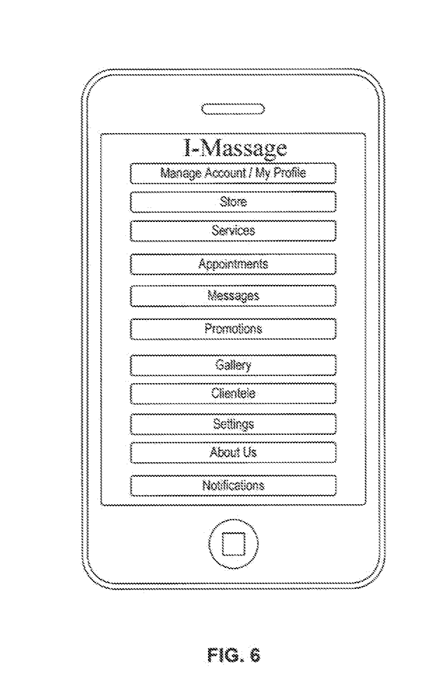

As seen in FIG. 6 after the therapists enter their credentials, they will be redirected to the dashboard of the application. In the dashboard following sections will be available which are as follows:
Manage Account/Profiles
Store
Services
Appointments
Messages
Promotions
Gallery
Clientele
Settings
About Us
Notifications

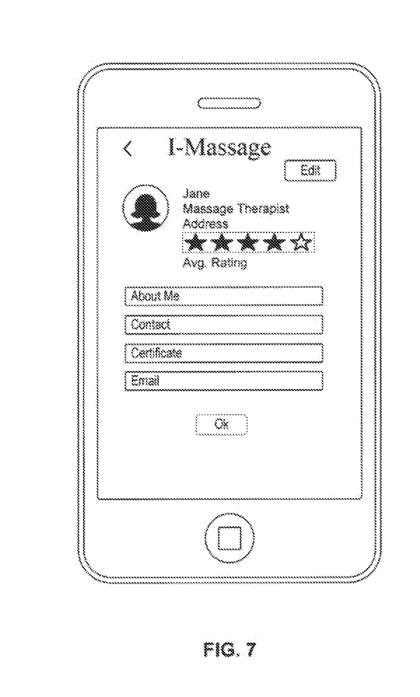

FIG. 7 shows the section of Manage Account/Profiles where the therapists would be able to manage their profiles and provide a little bit of an introduction about themselves, their expertise, certifications etc. Therapists can make their profiles from here, coupled with the average ratings as rated by their customers. There will be a back button on the top of the left most of the screen. When the therapist tap on it, they will be redirected to the dashboard.

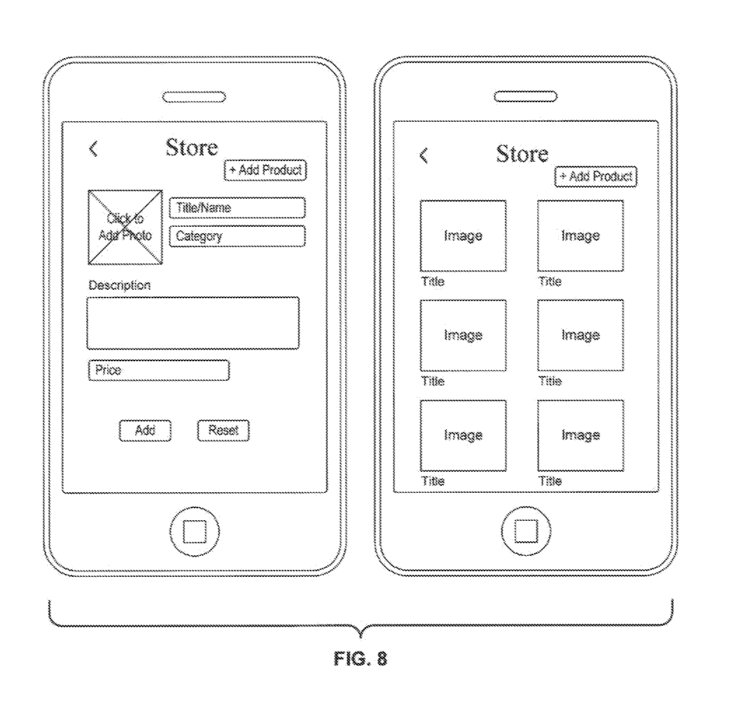

The section of the Store as shown in FIG. 8 allows therapists to upload several products on their store for the customers to view. When the therapists tap on “add a product” button, therapists would be required to upload a picture of the product. Therapist will have the option to either upload the picture from the gallery or take snapshots from their phone's camera. Once the image is uploaded, the therapists will need to add the product name, brief description and the price of the product. Upon saving this, the product will be showcased for the users on the Therapist's Store page. There will be a back button on the top of the left most of the screen. When the therapist taps on it, they will be redirected to the dashboard.

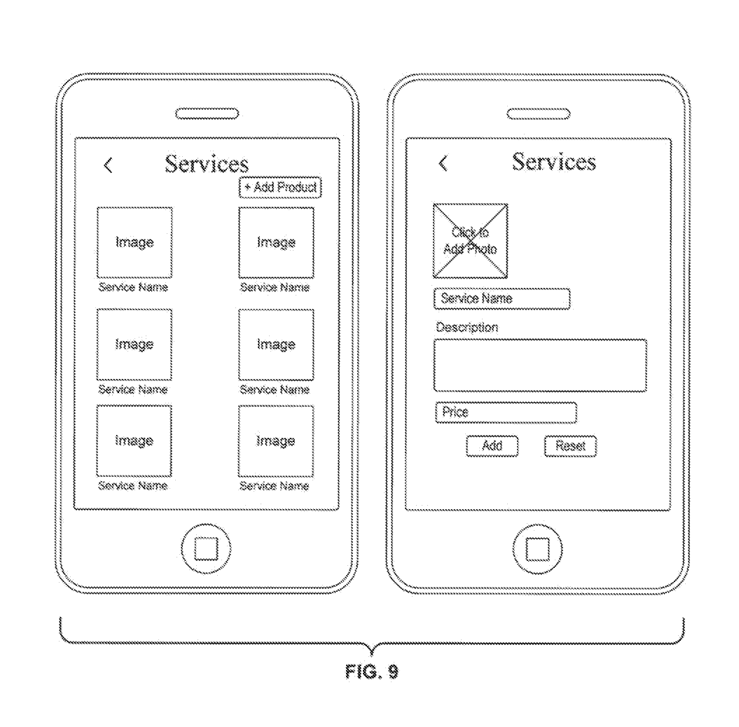

FIG. 9 shows the section of Services where the therapist would be able to add services they will offer to their customers along with the price list and the brief description of the service. Therapist will facilitate their customers with their services. Services like head massage ($10), neck massage ($5), shoulder massage ($15), Full body massage ($50), Hair Massage ($10) etc. Therapist can add the massage package as well like Head, Hair, and Shoulder Massage ($30). There will be a back button on top of the left most of the screen. When the therapist tap on it, they will be redirected to the dashboard. The sample prices listed herein are only used to brief about the process.

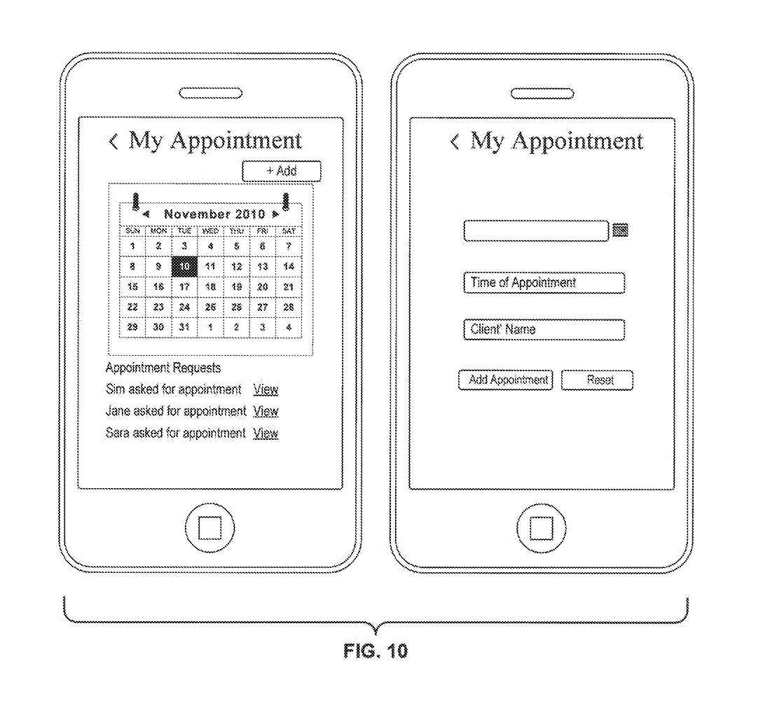

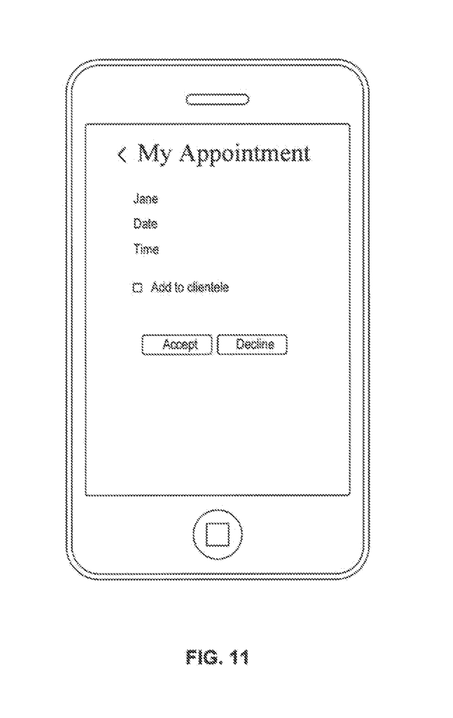

The section of Appointments shown in FIGS. 10-11 enables the therapists to add appointments manually from this section. The therapists can manually update the calendar based on their bookings and also confirms requests for slots sent by the customers. Therapist can view their bookings when they tap on view. If the therapist wants to add appointments, they will tap on add. This will redirect to another screen where they will be need to enter the date, time & client's name. If the therapist wants to add the particular client into their clientele, then they will mark check on ‘add to clientele’. After this action the client will be added in the clientele. There will be a back button on top left of screen. When the therapist taps on it, they will be redirected to the last viewed screen of application.

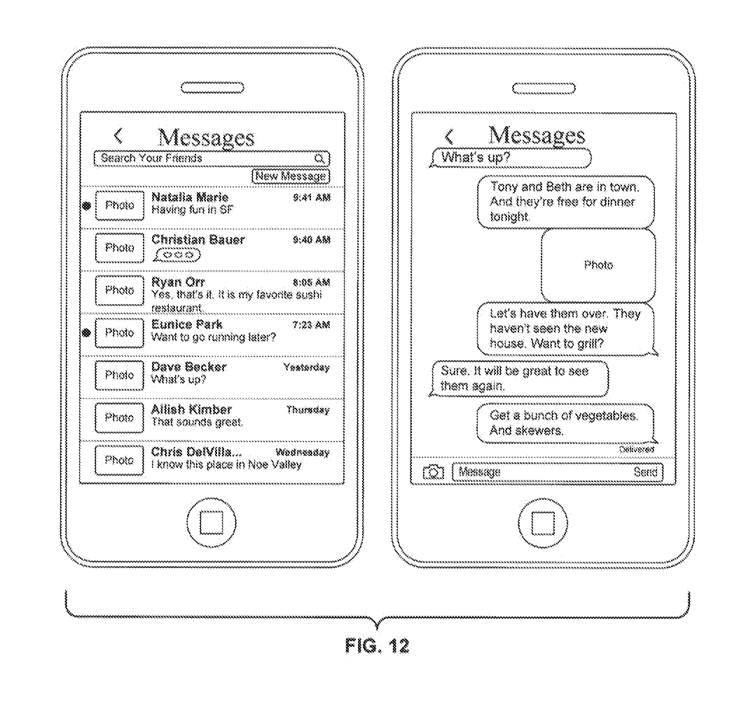

FIG. 12 illustrates the section of messages through which the massage therapists would be able to view all private messages sent to them by the customers and reply to them. The message interface of this application will be similar to Facebook® where they would be able to change their online status (busy, away, online etc) and see their client's status to chat with them by exchanging messages almost in real-time. There will be a navigation icon on the top left of the screen. When the user taps on this icon, the user can select the different sections of the application. When the user taps on any section, they will be redirected to the main screen of the selected section.

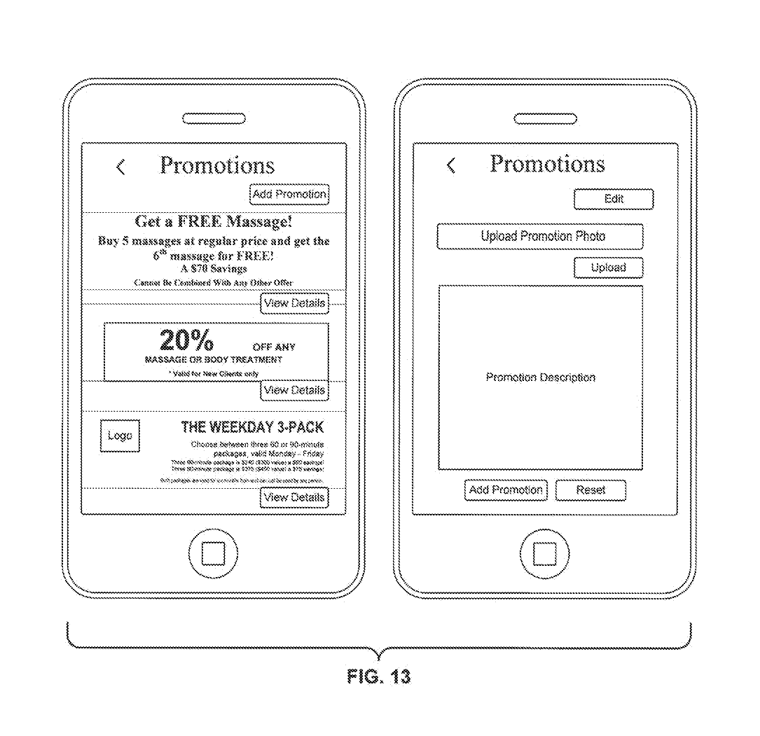

The section of Promotions shown in FIG. 13 allows the massage therapist to upload and manage the promotional activities like special offers, gift cards, deals and coupons. This section will help develop customers and keep the existing one coming back to therapist. If the therapist taps on add promotion that is available on the right of the screen, they will taking to another screen where the therapist can enter the description and image of the promotion. There will be a back button on the top left of the screen. When the therapist tap on it, they will be redirected to the last viewed screen of the application.

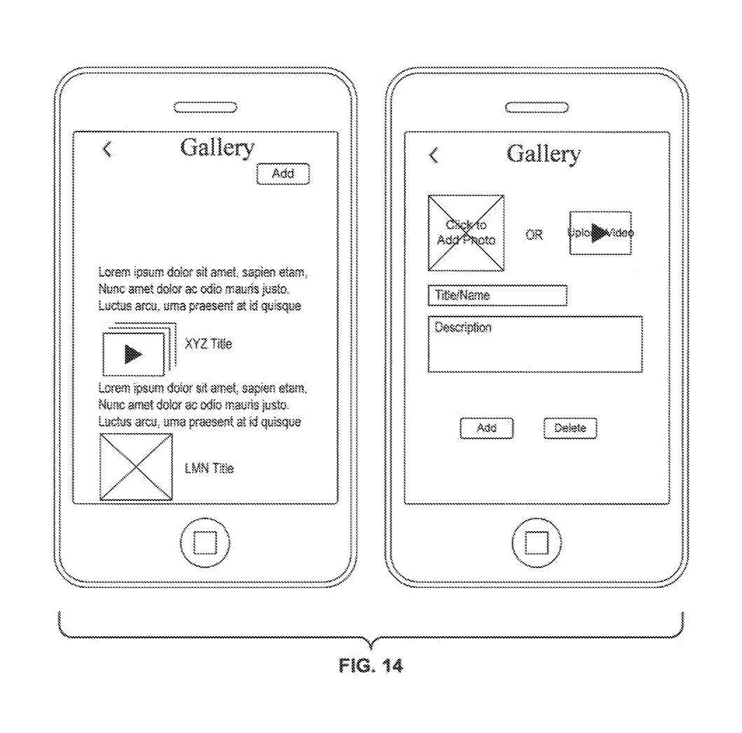

In the gallery of the application as shown in FIG. 14, there will be videos or images of the therapist to showcase their work. There will be an add icon on the top right of the screen. When therapist taps on this icon, they can upload more videos or images. There is a navigation icon on the top left of the screen. The user can tap on this icon and select the different sections of application. When the user tap on any section, they will be redirected to the main screen of the selected section.

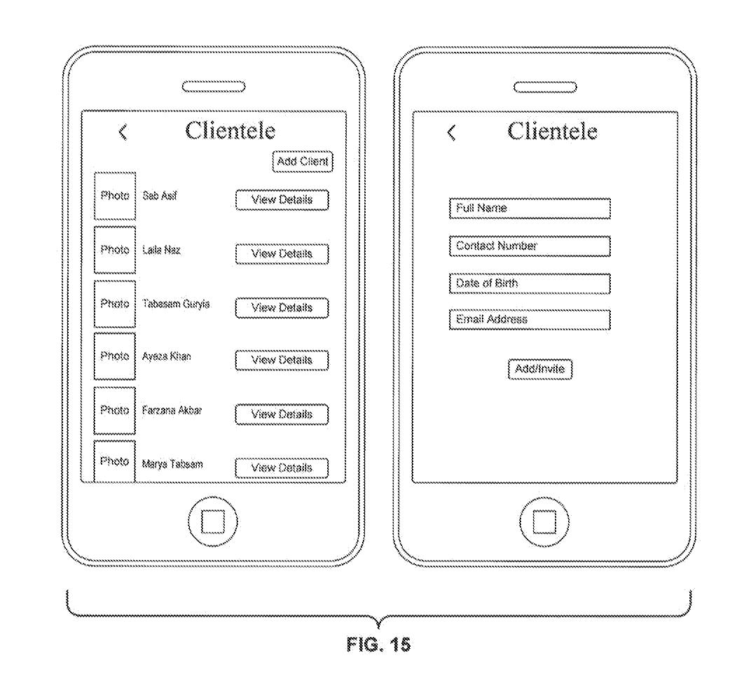

Through the section of Clientele shown in FIG. 15, the massage therapist can add the clients and view those that have been added. There will be an add clients button on top right of the screen. When the therapists wants to add a new client, they will tap the add clients button. If the therapists taps on all clients, they will see the names and details of them. The details of the clients are as follows:
Full Name
Contact Number
Date of Birth
Email ID

At the bottom of the screen the therapists can see the birthday details of their clients. There is a back button on the top left of the screen. When the therapist taps on it, they will be redirected to the last viewed screen of the application.

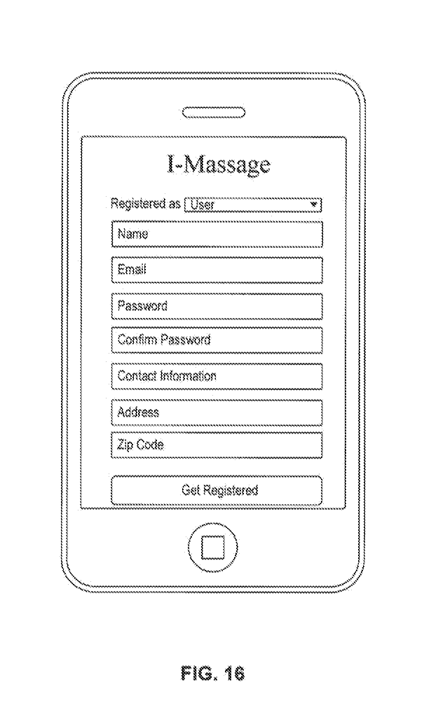

When the customers want to login, they will enter into the application after entering their credentials. Customer can manage their activities through this section as displayed in FIG. 16.

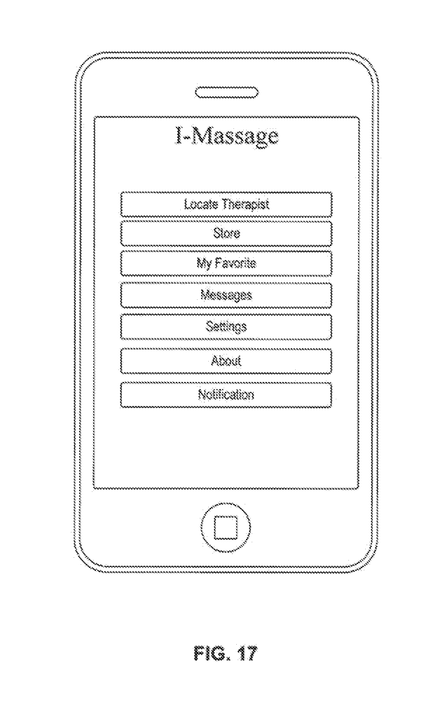

In the customer dashboard as shown in FIG. 17, following sections will be available which are as follows:
Locate Massage Therapist
Store
My Favorites
My Appointments
Message
More
Settings
About
Notifications

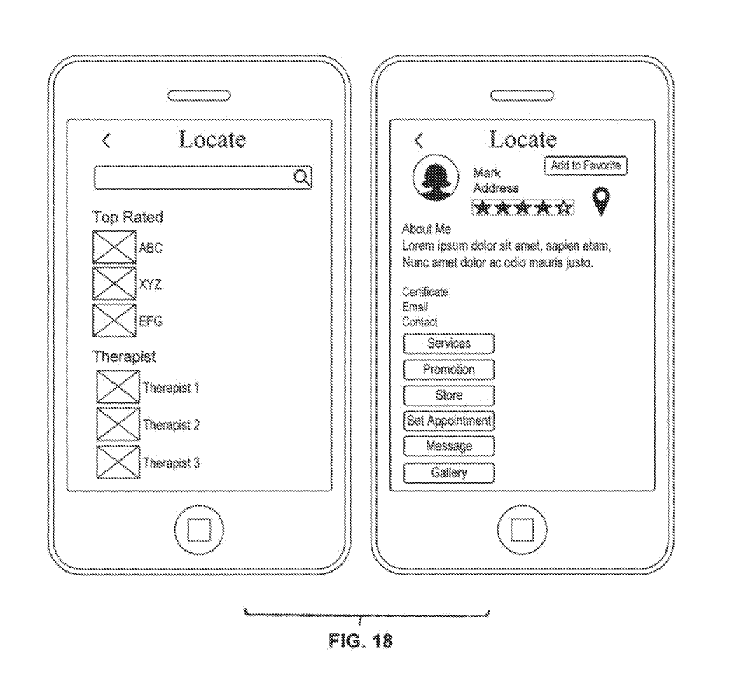

FIG. 18 is a screenshot of the section to Locate Massage Therapist. Through this section, customers can easily locate all therapists shop in their vicinity via GPS/Zip code. The customers can view the complete profile of the therapists along with their details like certifications, specialties, ratings, services. The therapist will also offer their price list, offers, pictures gallery and appointments. The customers can easily tap on each massage therapist on the map to carry out the following functions for each massage therapist listed within the application.
View Profiles.
Add to favorites.
Rate the therapists.
Service with price list.
View Promotions offered by different therapists.
Check Out their Store
Set Appointment
Send Message
Chat
View Gallery
Locate Therapist

There will be a back button on top left of the screen. When therapist taps on it, they will be redirected to the last viewed screen of the application.

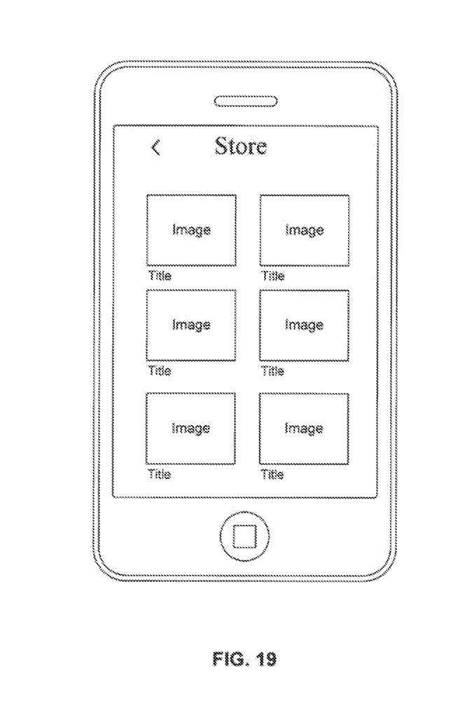

In the store shown in FIG. 19, customers can view the items uploaded by the different therapists. In this section, customers can see the vast range of items on each therapist's store. There will be a back button on top left of the screen. When the therapist taps on it, they will be redirected to the last viewed screen of the application.

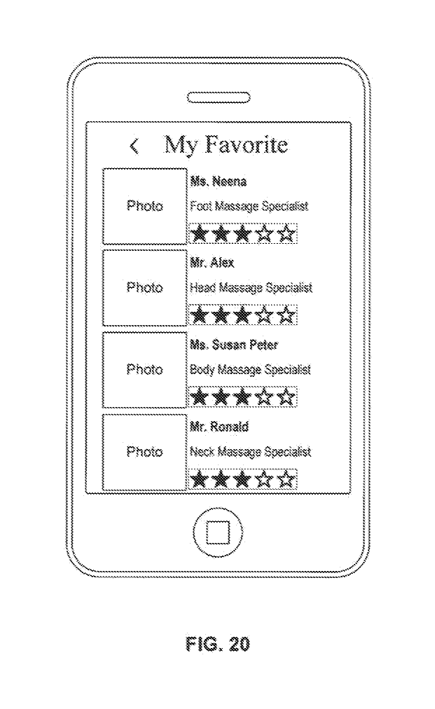

Through the My Favorites section (shown in FIG. 20), customers or users will manage their favorite massage therapists. Customers can locate their favorite massage therapist through this section for quick reference and for customer's convenience and to chat with the therapists. There will be a back button on top left of the screen. When therapist tap on it, they will be redirected to the last viewed screen of the application.

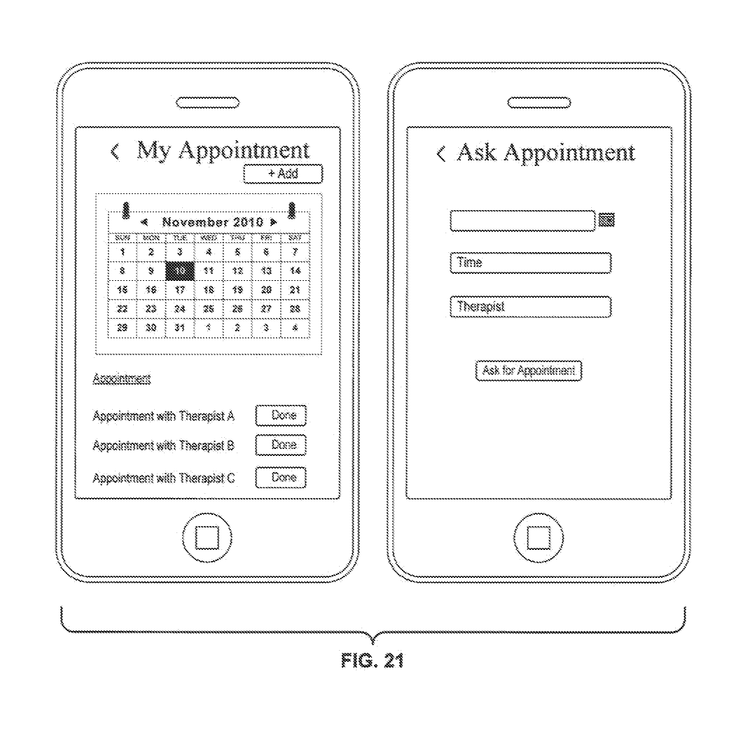

This “My Appointment” section shown in FIG. 21 allows the customers to see a calendar which would show their scheduled appointments and requested bookings with different therapists. After the confirmation of booking by the massage therapist, the user would be notified with the notification alert. There will be a back button on top left of the screen. When therapist taps on it, they will be redirected to the last viewed screen of the application.

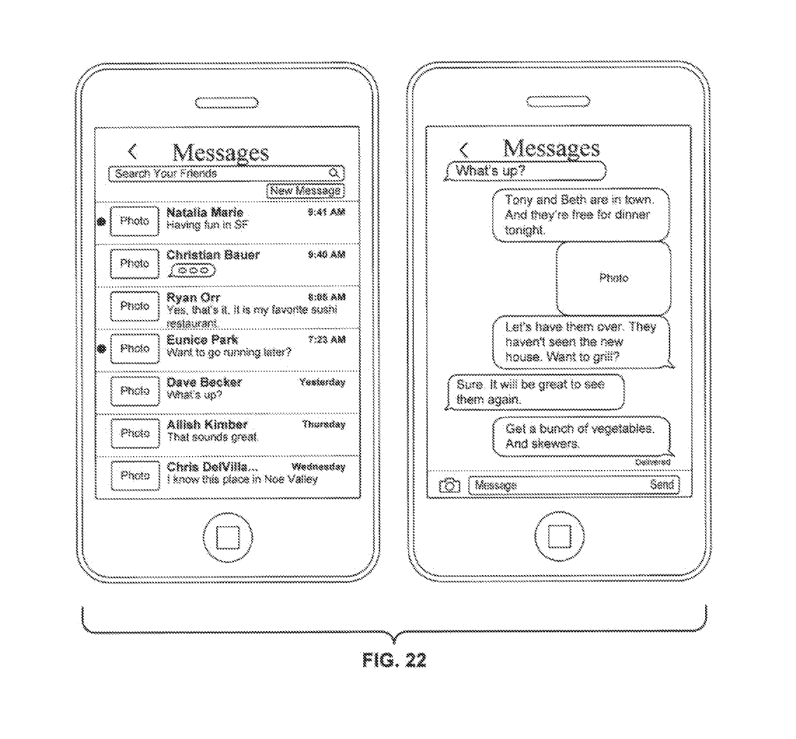

FIG. 22 shows the message section. When the customers tap on the message, they will be redirected to the main message screen. Through this section, the customers can chat with their massage therapists. There will be a back button on the top of the left most of the screen. When the therapist tap on it, they will be redirected to the last viewed screen of the application.

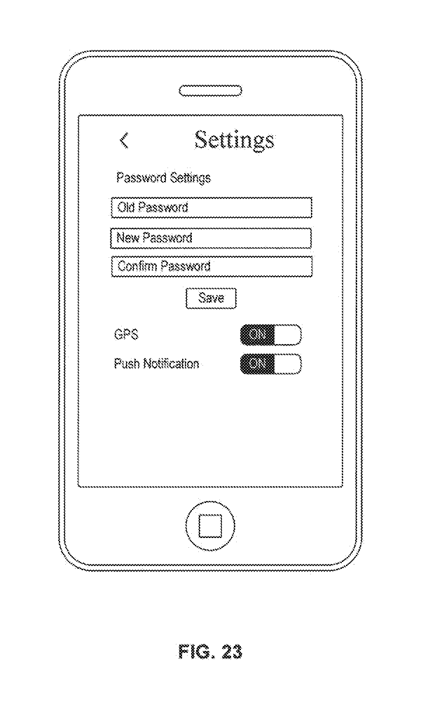

Through the settings section shown in FIG. 23, customers can manage their preferences and other settings of the application. Customers can manage appointment confirmation (on/off), new therapist added (on/off), application updates (on/off), GPS (on/off), message alert (on/off) and notification (on/off). There will be a back button on top left of the screen. When therapist taps on it, they will be redirected to the last viewed screen of the application.

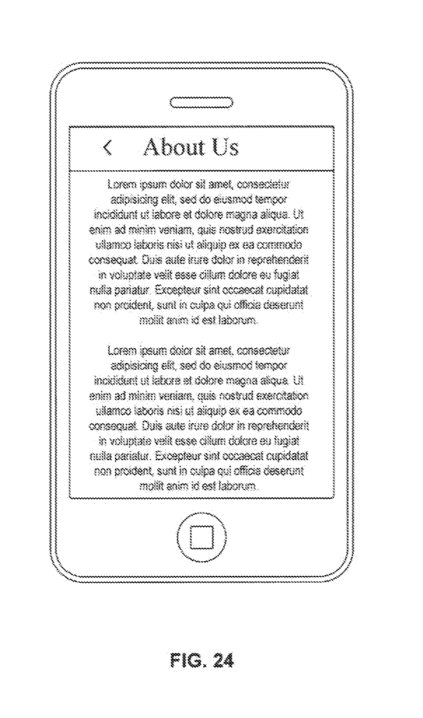

Through the About Us section shown in FIG. 24, application users can see all the details regarding the application and the company. There will be a back button on the top left of the screen. When the application user taps on it, they will be redirected to the last viewed screen of the application.

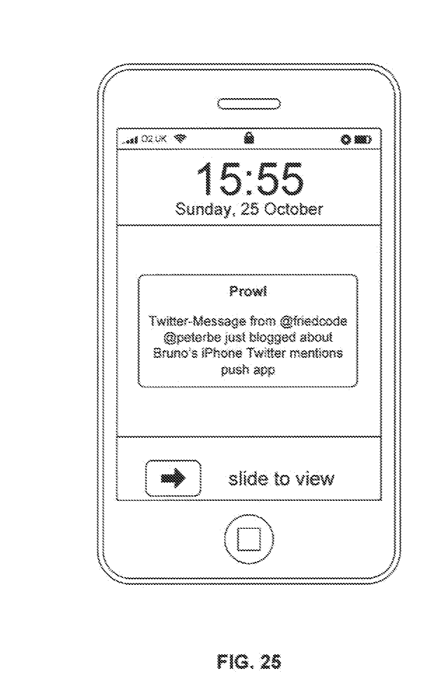

FIG. 25 shows pushed notifications. All notifications pushed by the administrators, will be shown on the app with a red circle over it. Notifications include App updates, Subscription fee due alert, client's birthday alert etc. Application users will manage these notification turn on/off from the settings of the application.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A method for bridging the gap between professionals and customers, the method comprising:
providing an interface for professionals in an application that runs on a mobile device over a communication network to log in using a professional's identification and associated information, manage profiles, upload and delete products and services offered to customers, add and update appointments, interact with customers, and add clients and view clients that have been added;
providing an interface for customers in the application that runs on the mobile device over the communication network to log in using a customer's identification and associated information, search professionals, view the products and services offered by each professional, manage favorite professionals, setup and view appointments with different professionals, and interact with professionals;
receiving the professional's identification and associated information by the server system over the communication network from the mobile device;
storing the professional's identification and associated information at a database and verifying that the professional registered with the application;
receiving the customer's identification, associated information and search request for the professionals by the server system over the communication network from the mobile device;
accessing the database stored information pertaining to the professionals registered with the application;
retrieving from the database the associated information for the matched professionals; and
transmitting Thorn the server system over the communication network the matched professionals associated information to the customer and displaying via the interface for customers on the mobile device.

2. The method of claim 1, wherein the customer interface allows customers to search professionals according to geographical area.

3. The method of claim 2, wherein the interface for professionals allows the professionals to provide a price list along with the products and services offered to the customers and brief description of the services.

4. The method of claim 3, wherein the interface for professionals allows the professionals to upload and manage promotional activities and upload videos or images to showcase their work in a gallery, and the interface for customers allows the customers to view the promotional activities and professional's work gallery.

5. The method of claim 4, wherein the interface for professionals allows the professionals to change their online status and see their client's status and chat with one another in real-time.

6. The method of claim 5, wherein the interface for customers allows the customers to rate different therapists.

7. The method of claim 6, further comprising computing the average of the ratings of each professional registered with the application along with each professional's profile.

8. The method of claim 7, wherein the interface for customers avows the customers to search all professionals in their vicinity via GPS and Zip code and view the complete profile of the professionals along with their details including certifications, specialties, ratings, services, price list, promotion offers, pictures gallery and appointments.

9. The method of claim 8, wherein the interface for customers avows the customers to manage appointment confirmation, new professionals added, application updates, GPS, message alert and notification.

10. The method of claim 9, further comprising notifying customers' appointment alert.

11. A system for bridging the gap between professionals and customers, the system comprising:
an interface for professionals in an application that runs on a mobile device over a communication network to login using the professional's identification and associated information;
an interface for customers in the application that runs on the mobile device over the communication network to login using customer's identification and associated information, and to place search request for professionals per need,
a server system that receives the professional's identification and associated information or the customer's identification and associated information, and verifies that the professional is registered with the application; and
a database storing the professional's identification and associated information as well as the customer's identification and associated information;
wherein the server system accesses the database to retrieve the matched professional's associated information upon the search request placed by the customer and transmits the associated information over the communication network to display via the interface for customers on the mobile device.

12. The system of claim 11, wherein the professional's associated information comprising a name of the professional, information regarding the physical location of the professional, and a promotional offer offered by the professional.

13. The system of claim 12, wherein the professionals are physical or massage therapists and the associated information comprising therapists' profiles, introduction about them, their expertise, certifications, services offered, products offered, picture gallery, and appointment calendar can be managed by the therapists.

14. The system of claim 11, wherein the therapist's profiles are coupled with ratings as rated by customers.

15. The system of claim 11, wherein the interface for professionals allows the professional to communicate with the customer through messenger.

16. The system of claim 14, wherein the server system sends the professional push notifications concerning upcoming appointments, client's birthdays, subscription fee due alert, app updates, and received messages.

17. The system of claim 16, wherein the interface for professionals allows the therapists to view their bookings and lists of clienteles.

18. The system of claim 11, wherein the interface for customers allows the customers to create and add/remove the professionals from their favorites.

19. The system of claim 11, wherein the customer interface allows the customers to ask for appointment with the professional.

20. The system of claim 11, wherein the interface for professionals allows the professional to manage the settings of the application including turn on/off notifications.
